(19) United States
(12) Patent Application Publication
(10) Pub. No.: US 2004/0193343 A1
(43) Pub. Date: Sep. 30, 2004

(54) Method and apparatus for controlling a telematics system

(75) Inventors: Adrian Tan, Farmington Mills, MI (US); Sue Bai, Wixom, MI (US)

Correspondence Address: FOLEY AND LARDNER, SUITE 500, 3000 K STREET NW, WASHINGTON, DC, 20007, US

(73) Assignee: NISSAN TECHNICAL CENTER NORTH AMERICA, INC.

(21) Appl. No.: 10/402,157

(22) Filed: Mar. 31, 2003

(51) Int. Cl. G06F 17/00

(52) U.S. Cl. 701/36; 701/1

(57) ABSTRACT

A vehicle is provided with an audio system having audio buttons, and a telematics system for wireless communication to the vehicle. The audio buttons are configured to select audio content and to select telematics content on the telematics system.

### BACKGROUND OF THE INVENTION

A. Field of the Invention

The invention relates generally to wireless communication systems, and more particularly to a method and apparatus for controlling a telematics system on a vehicle.

B. Background of the Invention

Wireless communication systems for communicating between a mobile platform (e.g., a vehicle) and a base station (e.g., a server at a service provider) are known. Lately, wireless communication systems have been introduced into the consumer market as options on vehicles such as luxury sedans, family mini-vans and cars, light trucks, sport utility vehicles, and the like, to enhance the functionality of these vehicles. One such system is widely known as OnStar®, and is offered by General Motors Corp. as a subscription service on several of their consumer vehicles. Another such system is described in U.S. Pat. No. 6,282,491, which is incorporated by reference herein in its entirety.

Wireless communication systems installed by original equipment manufacturers (OEMs) in vehicles are generally known as telematics systems, the word “telematics” representing a combination of “computers” and “telecommunications” to describe a computer mounted within a vehicle to wirelessly communicate with a central service provider. These telematics systems have been used to provide real-time traffic information to drivers (see “GDT And Traffic-Cast To Deliver Real-Time Traffic Information”, Mar. 20, 2003 by ITS America; and U.S. Pat. No. 6,426,709), to convey public safety announcements (see “Communications Industry Considers Measures To Ensure It Meets The Needs Of Public Safety During Crisis”, Mar. 17, 2003 by ITS America), to perform navigation and entertainment features (see “Product Innovations Drive The Emerging Automotive Entertainment And Navigation Systems Market”, Mar. 19, 2003 by ITS America) and many more applications (see generally U.S. Pat. No. 6,282,491 referenced above); the above referenced articles and patents being hereby incorporated by reference in their entirety.

With telematics systems becoming more highly sought after by the consumer market, due in part to the wider variety of applications available thereon, a need exists for reducing the manufacturing cost of vehicle installed telematics systems, and for improving their ease of use for the common consumer.

### SUMMARY OF THE INVENTION

According to one aspect of the present invention, a vehicle is provided with an audio system having audio buttons to select audio content, and a telematics system for wireless communication to the vehicle. The audio buttons are configured to also select telematics content on the telematics system.

According to another aspect of the present invention, a telematics communication system for a mobile platform is provided with a user interface including a plurality of preset buttons, the preset buttons being configured to select a stored preset identification (ID) corresponding to a data content of interest, a processor electrically coupled to the user interface, and a wireless communicator electrically coupled to the processor. The processor is programmed to perform the following at least upon selection of one of the plurality of preset buttons: to transmit the stored preset identification (ID) for a selected preset button to a server via the wireless communicator, and to receive the data content of interest via the wireless communicator.

According to another aspect of the present invention, a method of accessing information in a wireless network is provided including the steps of initiating a wireless connection from a mobile platform to a server, transmitting a preset identification (ID) to the server, correlating a data content corresponding to the preset ID, and transmitting the data content corresponding to the preset ID to the mobile platform. Transmitting a preset ID to the server includes at least one of: selecting one of a plurality of preset buttons corresponding to the preset ID transmitted, selecting a next data content corresponding to the preset ID transmitted, and selecting a previous data content corresponding to the preset ID transmitted.

According to another aspect of the present invention, a telematics communication system is provided with means for selecting a data content of interest on a mobile platform, means for wirelessly communicating the data content selection to a server, and means for transmitting the data content of interest from the server to the mobile platform.

### BRIEF DESCRIPTION OF THE DRAWINGS

Advantages and features of the invention will become apparent upon reference to the following detailed description and the accompanying drawings, of which:

FIG. 1 is a block diagram of a vehicle with a telematics unit and an audio system according to an embodiment of the present invention.

FIG. 2 is a block diagram of components in a telematics unit according to an embodiment of the present invention.

FIG. 3 is a flowchart of a method of accessing information in a wireless network using at least one audio preset button according to an embodiment of the present invention.

FIG. 4 is a flowchart of a method of storing a preset identification (ID) corresponding to an audio preset button according to an embodiment of the present invention.

FIG. 5 is a flowchart of a method of accessing information in a wireless network by transmitting a request for a next data content according to an embodiment of the present invention.

FIG. 6 is a flowchart of a method of accessing information in a wireless network by transmitting a request for a previous data content according to an embodiment of the present invention.

### DETAILED DESCRIPTION OF SPECIFIC EMBODIMENTS

Reference will now be made in detail to presently preferred embodiments of the invention. Wherever possible, the same reference numbers will be used throughout the drawings to refer to the same or like parts. It should be appreciated that while the following description will refer to a wireless connection such as a cellular channel, other communication formats are also within the scope of this invention (e.g., a radio channel, a satellite channel, a blue tooth/network channel, etc.).

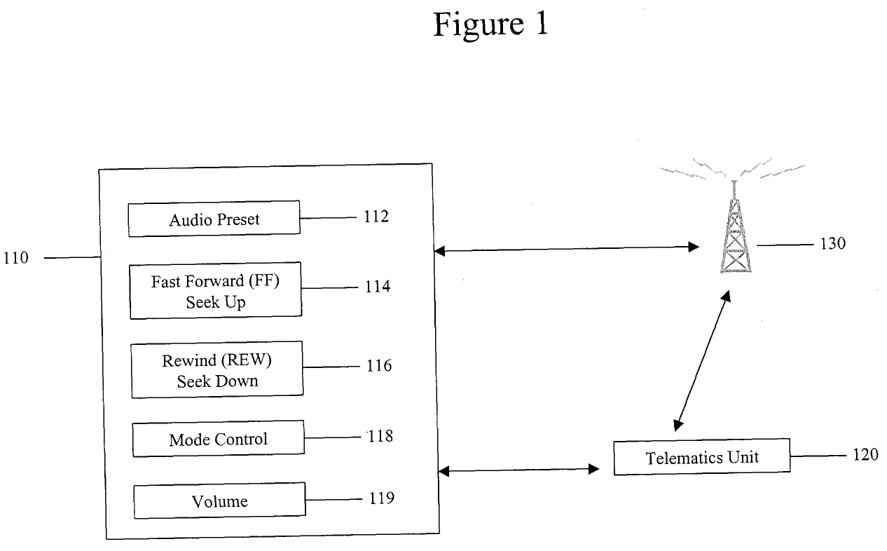

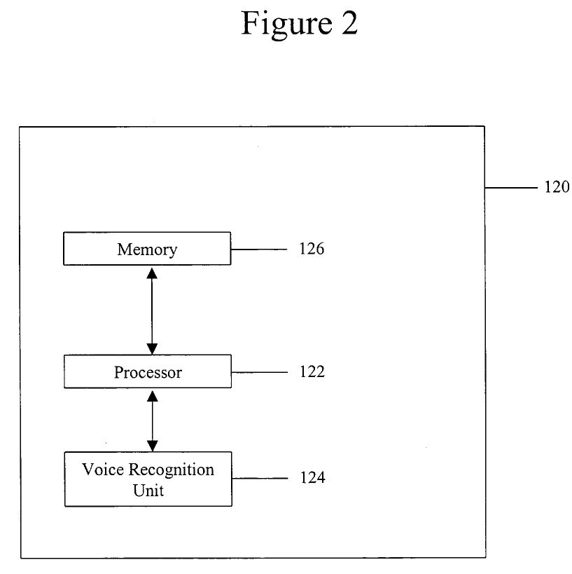

A vehicle including a telematics system according to one embodiment of the present invention, is shown in the block diagram of FIG. 1. More specifically, the vehicle includes an audio system 110, a telematics unit 120, and a wireless communicator 130. Preferably, the audio system 110 includes a plurality of audio preset buttons 112, Fast Forward (FF)/Seek Up button(s) 114, Rewind (REW)/Seek Down button(s) 116, Mode Control button(s) 118, and volume control knob/button 119. Moreover, the telematics unit 120 preferably includes a processor 122 for performing various telematics processing/control functions, a memory 126 for storing preset identifications (ID), and a voice recognition unit 124 as shown in FIG. 2. It should be appreciated that the memory 126 and/or voice recognition unit 124 may or may not be separate external components, and/or may be incorporated as part of the audio system 110. Moreover, while the audio system 110 and telematics unit 120 are shown in FIG. 1 as separable units, they also may be implemented as a single combined unit (e.g., a bezel unit with appropriate operating software/electronics).

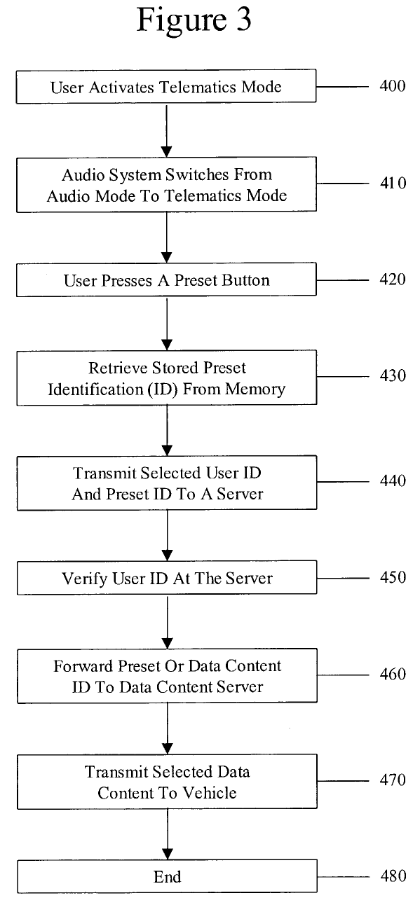

Operation of the aforementioned system according to one embodiment of the present invention will now be described with reference to FIG. 3. In step 400, a user activates a telematics mode on the vehicle, thereby initiating a wireless connection from the vehicle to a server, such as a verification server at a central service provider. By way of example, the user may initiate a wireless connection by pressing mode control button 118 of audio system 110 (FIG. 1), by making an appropriate voice command (e.g., “Telematics ON”) read and interpreted by the voice recognition unit 124 (FIG. 2), by activating a button on a hands-free phone (not shown) electrically coupled to the telematics unit 120, etc.

The audio system 110 then switches in step 410 from an audio mode to a telematics mode, in which the buttons 112, 114, 116, and 119 switch from audio control (e.g., radio station frequency preset IDs, fast forward/seek up, rewind (REW)/seek down, and volume) to command and control features for the telematics system. Accordingly, when a user presses a preset button 112 in step 420, the telematics unit 120 proceeds to step 430 and retrieves a stored preset ID from memory 126 corresponding to the particular preset button 112 selected. The telematics unit 120 then in step 440 transmits via the wireless communicator 130 the stored preset ID of the activated/selected audio channel preset button 112 to the server.

In addition, the telematics unit 120 preferably also transmits a user ID to the server in step 440 along with or prior to transmission of the stored preset ID. By way of example, the user ID may include subscription information to identify the user to the server for billing purposes. If the user ID is transmitted to the server in step 440, the server then verifies the user ID in step 450; e.g., correlating the user ID with a database of user IDs accessible by the server.

Once the user has been verified in step 450, the server then forwards the preset ID to a data content server in step 460. Alternatively, the server may automatically forward the preset ID to the data content server while verifying the user ID in order to save time, or may bypass the verification portion of steps 440 and 450 altogether if no verification procedure is used.

Additionally, the server referred to in step 440 may include data content server functionality rather than having distinct servers. Preferably, however, the data content server is maintained by a separate entity particular to the specific data content desired, such as a traffic service provider, a hotel registration service provider, a weather report service provider, etc. Preferably, however, the multiple service providers are integrated into a single data server. The data content server then transmits the selected data content to the vehicle directly in step 470, or by way of the server of steps 440 and 450.

The call may then be terminated in step 480 if no additional data content is required. The aforedescribed system provides improved integration of the audio system 110 of the vehicle with the telematics unit 120 over conventional designs, and provides for easy access for data contents of frequent interest by the user by combining the audio channel preset feature of the audio system 110 with a preset ID storage feature for the telematics unit 120.

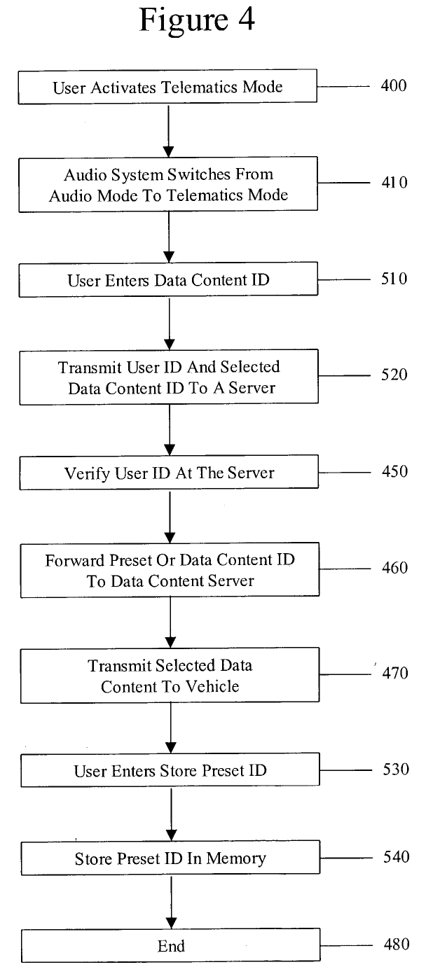

According to another embodiment of the present invention, a user may desire to store a new preset ID for one of the audio presets 112. Hence, a storage method according to another embodiment of the present invention for use with the aforementioned operation is shown in the flowchart of FIG. 4. According to this embodiment, the user enters a data content ID in step 510. By way of example, the user may type a particular data content ID into a keyboard input device (or virtually represented in a touch screen on a bezel device as part of the telematics unit 120) or write into a graffiti tablet (not shown) coupled to the telematics unit 120, by speaking the particular data content ID into the voice recognition unit 124, etc. The user ID and selected data content ID are then sent to the server in step 520 (similar to step 440 of FIG. 3), and processed in steps 450, 460, and 470 as previously described.

In this embodiment, the user also enters “store preset ID” in step 530. By way of example, the user my depress and hold the volume button 119 for a predetermined time period while simultaneously depressing the particular preset button 112 to correspond to the data content ID, or may simply depress the particular preset button 112 for a predetermined time period. The preset ID is then stored in memory 126 in step 540 such that the designated audio preset button 112 corresponds to the designated telematics content channel. Other storage techniques are also plausible, as would be readily apparent to one of ordinary skill in the art after reading this disclosure.

Thus, according to one aspect of the present invention, if the preset ID is unknown to the user (e.g., the user is parsing through various channels), the preset ID may be transmitted to the vehicle along with the data content in step 470. Alternatively, when the user enters “store preset ID” in step 530, the vehicle may request the preset ID from the data content server, which then transmits the preset ID to the server. In either case, the user advantageously does not need to know the preset ID to have it stored. According to yet another aspect of the present invention, if the user does know an actual preset ID, the user may enter it into the telematics unit 120 when initially requesting that data content, along with the “store preset ID” step 530, or in response to an appropriate prompting by the telematics unit 120 as part of or after step 530; Other configurations are also plausible, as would be readily apparent to one of ordinary skill in the art after reading this disclosure.

This storage method allows the user to update the preset IDs for future use. It should be appreciated that this storage method may be combined with other features, such as storing unique preset IDs in a user specific profile for different users of the vehicle (e.g., husband and wife, parent and child, etc.), which can then enter their particular user ID similar to that described above for the data content ID in step 510 (or similarly on the internet if the data content server or vehicle is internet accessible). The user specific profile may then be stored in the memory 126, or on the server which can transmit the user specific profile to the vehicle after verification step 450.

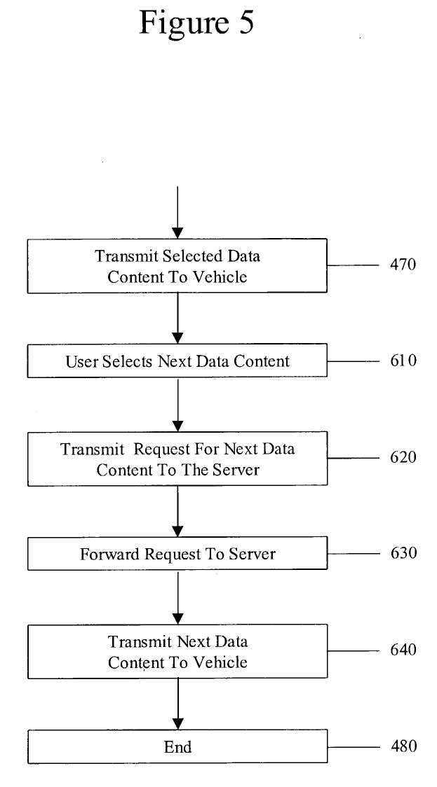

A browsing option according to another embodiment of the present invention is shown in the flowchart of FIG. 5. As shown in FIG. 5, the user has already requested a data content (e.g., by any one of the previously described embodiments), which has been transmitted to the vehicle in step 470. At this point, a user desiring to receive a next data content (e.g., the “7-day forecast” after having viewed the “present weather conditions” from a weather service provider) selects in step 610 a next data content by depressing one of a fast forward (FF) button and a seek up button 114 on the audio system 110, or the like. The telematics unit 120 then transmits a request for the next data content to the server in step 620. Upon receipt of the request, the server may again verify the user ID, or may automatically forward the request to the data content server in step 630 (because the user has previously been identified when the previous data content was sent), which transmits the next data content to the vehicle in step 640 (similar to step 470).

According to one embodiment of the present invention, a “request” for the next data content (or previous data content as will be described below) transmitted by the telematics unit 120 is a pre-recorded voice message interpreted by the voice recognition unit 124 in the telematics unit 120, or in a voice recognition unit in the server (not shown). In this manner, the telematics unit 120 can communicate via wireless communication channels that are only able to interpret voice communication commands. A similar feature may also be incorporated with the preset buttons 112 described above.

It should also be appreciated that the fast forward and seek up button 114 (and/or the rewind (REW) button and seek down button 116 for subsequent embodiments) may include the dual mode seek buttons available on many OEM audio systems 110. By way of example, some OEM audio systems 110 include both a fine tuning seek button (e.g., a tuning knob) and a search/seek button. Hence, the present invention may proceed to a next data content within the same genre of data content (see weather report example) if a fine tuning seek button is depressed, or may proceed to a next data content within an entirely different genre (e.g., sports updates) if a search/seek button is depressed. By way of example, turning a tuning knob may switch from a news broadcast to a sports broadcast.

The aforementioned embodiment allows a user, who is already familiar with storing favorite local FM radio station channels using the preset buttons, to readily use and store favorite data contents on the telematics unit 120.

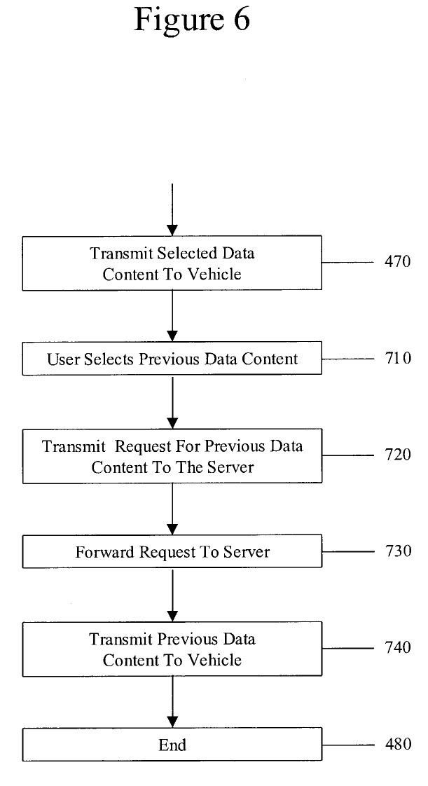

Additionally, a browsing option according to yet another embodiment of the present invention is shown in the flowchart of FIG. 6. As with the previous embodiment, the user has already requested a data content (e.g., by any one of the previously described embodiments), which has been transmitted to the vehicle in step 470. At this point, a user desiring to receive a previous data content (e.g., the “present weather conditions forecast” after having viewed the “7-day forecast”) selects in step 710 a previous data content by depressing one of a rewind (REW) button and a seek down button 116 on the audio system 110, or the like. The telematics unit 120 then transmits a request for the previous data content to the server in step 720. Upon receipt of the request, the server may again verify the user ID, or may automatically forward the request to the data content server in step 730, which transmits the previous data content to the vehicle in step 740 (similar to step 640).

The aforementioned embodiments of FIGS. 5 and 6 thus provide additional functionality not available on conventional telematics systems. The additional functionality allows users to more easily surf available data contents, rather than having to enter a new data content ID for each data content of interest. The user may then store the data content currently being viewed as described above in reference to FIG. 4.

Thus, methods and apparatuses for controlling a telematics system have been described according to the present invention. Many modifications and variations may be made to the techniques and structures described and illustrated herein without departing from the spirit and scope of the invention. By way of example, the audio system 110 and telematics unit 120 may be combined in a single bezel unit as described. Similarly, the buttons 112, 114, 116, 118, and 119 may be implemented as “virtual” buttons on a touch screen display, on a steering column/wheel assembly, on a type of hardswitch, or by any other convenient manner. Accordingly, it should be understood that the methods and apparatus described herein are illustrative only and are not limiting upon the scope of the invention.

What is claimed is:

1. A vehicle, comprising:
an audio system having audio buttons to select audio content; and
a telematics system for wireless communication to the vehicle,
wherein the audio buttons are configured to also select telematics content on the telematics system.

2. The vehicle of claim 1, further comprising:
a steering column/steering wheel assembly,
wherein at least one audio button is positioned on the column/steering wheel assembly.

3. The vehicle of claim 1,
wherein the audio buttons comprise audio preset buttons, and
wherein when operating in a telematics mode, an audio preset button selects a stored preset identification (ID) corresponding to a data content of interest.

4. The vehicle of claim 1,
wherein the audio buttons comprise at least one of seek up button(s) and fast forward (FF) button(s),
wherein at least one of the seek up button and the FF button selects a next data content, and
wherein upon activation of at least one of the seek up button and the FF button, the telematics system transmits a request for a subsequent data content corresponding to the next data content.

5. The vehicle of claim 1,
wherein the audio buttons comprise at least one of seek down button(s) and rewind (REW) button(s),
wherein at least one of the seek down button and the REW button selects a previous data content, and
wherein upon activation of at least one of the seek down button and the REW button, the telematics system transmits a request for a subsequent data content corresponding to the previous data content.

6. A telematics communication system for a mobile platform, comprising:
a user interface including a plurality of preset buttons, the preset buttons being configured to select a stored preset identification (ID) corresponding to a data content of interest;
a processor electrically coupled to the user interface; and
a wireless communicator electrically coupled to the processor,
wherein the processor is programmed to perform the following at least upon selection of one of the plurality of preset buttons:
to transmit the stored preset identification (ID) for a selected preset button to a server via the wireless communicator; and
to receive the data content of interest via the wireless communicator.

7. The telematics communication system of claim 6, wherein the mobile platform comprises an automobile.

8. The telematics communication system of claim 6, wherein the wireless communicator comprises at least one of a radio transmitter/receiver, a cellular transmitter/receiver, and a satellite transmitter/receiver.

9. The telematics communication system of claim 6, wherein the user interface comprises an audio system.

10. The telematics communication system of claim 9, wherein the audio system includes at least one audio button positioned on a steering column/wheel assembly.

11. The telematics communication system of claim 9, wherein the plurality of preset buttons comprise audio channel preset buttons configured to input telematics control selections at least when operating in a telematics mode.

12. The telematics communication system of claim 11,
wherein the processor is further programmed to store a new preset ID corresponding to a new data content of interest for a selected audio channel preset button upon activation of a given audio channel preset button in combination with a storage selection.

13. The telematics communication system of claim 9,
wherein the audio system further comprises seek up button(s) and fast forward (FF) button(s),
wherein at least one of the seek up button and the FF button selects a next data content, and
wherein the processor is further programmed to transmit via the wireless communicator to the server a request for a subsequent data content corresponding to the next data content upon activation of at least one of the seek up button and the FF button.

14. The telematics communication system of claim 9,
wherein the audio system further comprises seek down button(s) and rewind (REW) button(s),
wherein at least one of the seek down button and the REW button selects a previous data content, and
wherein the processor is further programmed to transmit via the wireless communicator to the server a request to transmit a subsequent data content corresponding to the previous data content upon activation of at least one of the seek down button and the REW button.

15. A method of accessing information in a wireless network, comprising:
initiating a wireless connection from a mobile platform to a server;
transmitting a preset identification (ID) to the server;
correlating a data content corresponding to the preset ID; and
transmitting the data content corresponding to the preset ID to the mobile platform,
wherein transmitting a preset ID to the server includes at least one of:
selecting one of a plurality of preset buttons corresponding to the preset ID transmitted;
selecting a next data content corresponding to the preset ID transmitted; and
selecting a previous data content corresponding to the preset ID transmitted.

16. The method of claim 15, further comprising:
storing the preset ID on the mobile platform, the stored preset ID corresponding to a data content of interest.

17. The method of claim 15,
wherein transmitting the preset ID to the server includes one of selecting the next data content and selecting the previous data content,
wherein correlating the data content correlates a subsequent data content corresponding to next data content/previous data content, and
wherein transmitting the data content to the mobile platform transmits the subsequent data content to the mobile platform.

18. The method of claim 15, wherein the data content comprises an audio content.

19. The method of claim 15, wherein initiating the wireless connection comprises:
selecting the telematics call;
transmitting a user identification (ID) to the server; and
verifying the user identification (ID) on the server.

20. The method of claim 15, wherein the mobile platform comprises an automobile.

21. The method of claim 15, wherein the wireless connection comprises at least one of a radio channel, a cellular channel, and a satellite channel.

22. A telematics communication system, comprising:
means for selecting a data content of interest on a mobile platform;
means for wirelessly communicating the data content selection to a server; and
means for transmitting the data content of interest from the server to the mobile platform.

23. The telematics communication system of claim 22, wherein said means for selecting comprises means for proceeding to a next data content of interest.

24. The telematics communication system of claim 22, wherein said means for selecting comprises means for proceeding to a previous data content of interest.

25. The telematics communication system of claim 22, wherein said means for selecting comprises:
means for storing a plurality of preset identifications (ID) on the mobile platform; and
means for retrieving a given preset ID corresponding to the data content of interest upon activation of a preset button.

26. The telematics communication system of claim 22, further comprising:
means for identifying a user of the mobile platform.
